(19) United States
(12) Patent Application Publication
(10) Pub. No.: US 2008/0072247 A1
(43) Pub. Date: Mar. 20, 2008

(54) Method and System of Online Broadcasting

(76) Inventor: John Russell Barnard, Round Rock, TX (US)

Correspondence Address: CONLEY ROSE, P.C.;David A. Rose, P. O. BOX 3267, HOUSTON, TX, 77253-3267, US

(21) Appl. No.: 11/856,961

(22) Filed: Sep. 18, 2007

Related U.S. Application Data
(60) Provisional application No. 60/825,970, filed on Sep. 18, 2006.

(51) Int. Cl. H04N 7/025; H04N 7/173

(52) U.S. Cl. 725/32; 725/109

(57) ABSTRACT

Method and system of online broadcasting. At least some of the illustrative embodiments are methods comprising enabling a plurality of people from disparate physical locations to interact with each other via an Internet-based community, broadcasting a live stream of video through the Internet-based community to those of the plurality of people who elect to receive the live stream of video (wherein the live stream of video is provided from any of the plurality of people), and displaying the live stream of video on a video screen of each of the plurality of people who elect to receive the live video.

### CROSS-REFERENCE TO RELATED APPLICATION

This application claims the benefit of U.S. Provisional Patent Application No. 60/825,970, filed Sep. 18, 2006, titled “Method and System of Online Advertising and Broadcasting,” and which application is incorporated by reference herein as if reproduced in full below.

### BACKGROUND

Social networking web sites make money based on advertising revenue. The more users that can be attracted to a site, the greater the possible revenue stream. Advertising in the context of a social networking site has generally adopted strategies used outside the Internet context. However, while Internet-based advertising has worked successfully for many companies, such techniques fail to, or fail to fully, utilize the potential of the Internet from an advertising perspective.

### BRIEF DESCRIPTION OF THE DRAWINGS

For a detailed description of illustrative embodiments, reference will now be made to the accompanying drawings in which:

FIG. 1 illustrates a related art social networking customization screen;

FIG. 2A illustrates a user interface in accordance with some embodiments;

FIG. 2B illustrates a user interface in accordance with some embodiments;

FIG. 3 illustrates a system in accordance with some embodiments; and

FIG. 4 illustrates a method in accordance with some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

“Social networking site” in the specification and claims shall refer to an online or Internet-based community that enables members or users with diverse backgrounds and interests to interact with each other through services provided through the social networking site (e.g., profile/web-pages, text-based chat, electronic mail messages, voice over Internet Protocol (voIP) sessions).

### DETAILED DESCRIPTION

The following discussion is directed to various embodiments. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

The various embodiments are directed to Internet-based advertising. There are several aspects of the various embodiments that can operate standing alone; however, the various aspects may also be integrated to form an overall advertising package. The various aspects will be discussed individually first, and after the individual discussions the integrated embodiments are discussed.

Enhanced Social Networking and Online Communities

A social networking and online community (hereinafter just social networking site) Internet service allows individuals from disparate physical locations to communication for purposes of social interaction. A social networking site in accordance with the various embodiments has many potential features. One such feature is a real-time chat feature where two or more individuals converse either through a text-based interaction (e.g., communicate using features similar to Microsoft® Chat, Internet Messenger (IM)) or voice over Internet Protocol (IP) (voIP) technology.

Another possible feature of a social networking site is the hosting of web-pages where each user defines or personalizes the content. In some embodiments, the personalization of the content is providing personal information to populate fields of form-type web-page, and other members of the social networking site are enabled to peruse the personal information. In yet still other embodiments, the member has the ability to customize the web-page itself (e.g., background, layout, types of information provided). For purposes of this specification and claims, web-pages of a social networking site where members place personal information (whether the web-page is a form-type or highly customizable) is referred to as a personalized web-page or a profile. In some embodiments, the member's profile is available to anyone with Internet access, but in alternative embodiments access to a member's profile is limited to invitation-only viewing (e.g., placing the invitee on a “friends” list). In some embodiments, a keyboard or voIP interaction with another member exposes each member's profile to the other.

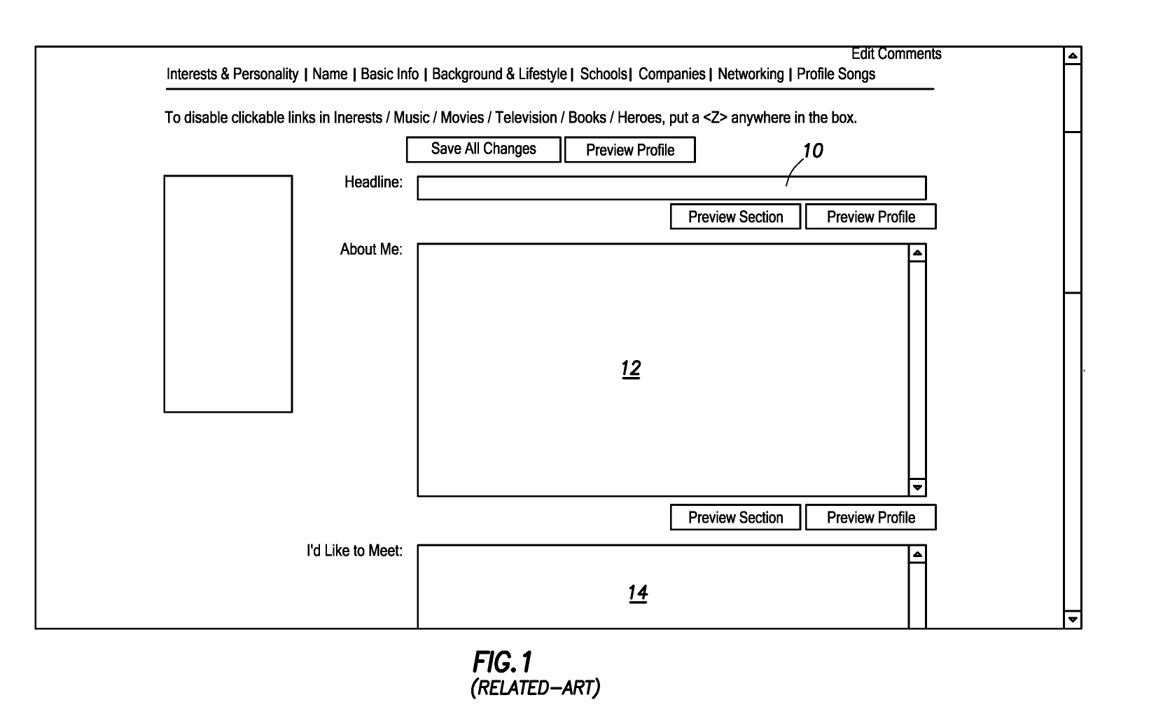

However, Internet-based social networking sites have an inherent flaw in that to personalize one's profile requires a working knowledge, if not fluency, in hypertext markup language (HTML). More specifically, to personalize the profile requires either the ability to draft detailed HTML code, or the ability to copy and modify HTML code drafted by others. In fact, an entire industry has evolved where members of social networking sites may purchase pre-configured and/or custom created HTML for use in personalizing one's profile. The problem is exacerbated in the related art by the fact not all the viewable area of one's profile is available for modification. FIG. 1 illustrates a screen shot of a customization screen of a social networking site of the related art. The paste-down boxes 10, 12 and 14 are designed for insertion of HTML, which paste-down requires at least a working knowledge of HTML to be useful.

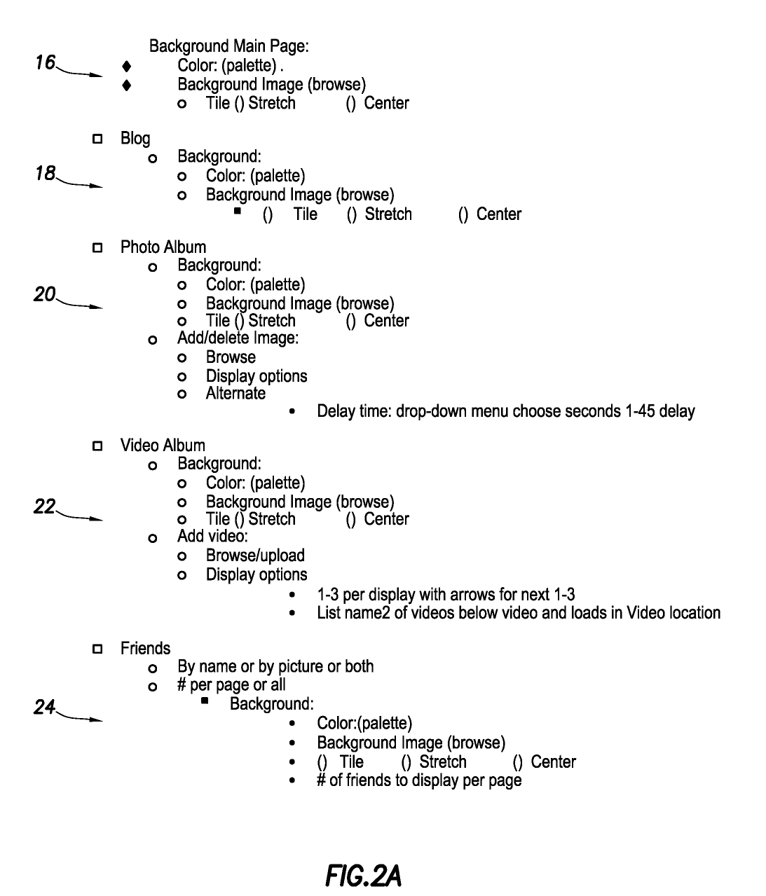

In order to address the limitations regarding HTML knowledge and/or non-standard modifiable area, a social networking site in accordance with at least some embodiments enables a user to personalize a profile using a drag-and-drop and/or point-and-click interface. FIG. 2A shows a portion of a user interface whereby a user may select from a plurality of possibilities for personalization for their profile. For example, a user may: select the background palette/pattern and orientation thereof as shown at 16; insert a blog portion and related parameters (e.g., color, presence of images, orientation of images) as shown at 18; insert a photo album and related parameters (e.g., colors, background images, orientations, image control and browsing features) as shown at 20; insert a video album and related parameters (e.g., colors, photo orientation, image control and browsing features) as shown at 22; and insert a friends section with related parameters (e.g., friend name, friend picture, and control and browsing features) as shown at 24. Likewise, FIG. 2B shows a portion of a user interface whereby a user may: insert a music album and related parameters (e.g., color, background images and orientations, display options and control features) as shown at 26; insert sections such as interests, personal details and links to interesting sites and latest news as shown at 28; insert custom boxes where, if the user is capable, custom HTML may be entered as shown at 30; and insert boxes that enable viewers of the profile to rate the profile at 32. Thus, most any feature of a web-page may be provided to the user through the user interface for the user's profile (e.g., HTML based motion graphics, sounds or theme music, borders, counters, and links to other web-pages) without the necessity of the user being fluent in HTML drafting.

An Internet-based social networking site that enables every user to personalize their profile, not just the those users who happen to be HTML fluent, may enable the provider of the social networking service the ability to charge users at least an initial fee, if not a periodic fee (e.g., yearly), for continued use of the social networking service.

Contests Conducted by and Through the Social Networking Site

The social networking site discussed to this point has been single minded of purpose in that profiles are for informational purposes only (i.e., one tells others about his/her web-page in the hope they visit to learn about the owner of the web-page). However, in accordance with at least some embodiments, the personalized profiles and/or other web-pages hosted by the social networking site contain contest entries by the user. In particular, in accordance with at least some embodiments the social networking site holds contests based on entries by and through personalized web-pages. Initial culling of entries is based on one or more of: visits to the profile and/or web-page containing or embodying the entry (e.g., a web-page decorating contest); votes cast by those viewing web-pages (e.g., again a web-page decorating contest); number of accesses to a contest entry (e.g., number of times a streaming video clip viewed); or ranking of entries by those accessing the entries. Thus, in at least some embodiments the users and/or members of the social networking site provide the data for the initial culling of the entries, and the social networking site has no part in the decision other than aggregating user votes.

Choosing a winner of a particular contest may be based solely on the culling as discussed above, but in other embodiments the highest ranking entries progress to a winner selection video program that is streamed live over the Internet. In particular, a select few of the top ranking entries from the initial culling are streamed live over the Internet, and Internet-based viewers are allowed vote. Broadcasting the winner selection show over the internet allows the entity providing the broadcasting service to track the number of viewers at any given time by internet protocol (IP) address. Stated otherwise, the social networking site gauges the number of Internet-based viewers by the number of unique IP addresses receiving the broadcast. Moreover, in some embodiments online voting for winners in the winner selection contest may be limited to one vote per IP address, thus reducing “ballot stuffing” in the winner selection contest. The winner of the contest may receive a cash prize (e.g., one million dollars), or the winner may receive a talent-specific prize, such as a recording contract.

An Internet-based social networking site that enables entry into various contests by and through the personalized web-pages may enable the provider of the social networking service the ability to charge contestant entrants at least an initial fee, if not a periodic fee, for continued use of the social networking site. Moreover, additional users that are not contestants may also be motivated to subscribe with fee to the social networking site to enable their voting and/or ranking of contest entries, not only at the period of time in which entries are culled by personalized web-page visitors, but also at the time of the live broadcast.

The contest-based social networking provides a unique advertising opportunity. In particular, when streaming the winner selection video program, the social networking site can provide advertising (e.g., banner advertising, 15, 30 and 60 second dedicated commercials, product testimonials within the program) with an advantage over electromagnetic wave-based broadcasting advertising media in that the advertiser will know, at the instant of the advertisement, how many users are logged onto the social networking service and/or receiving the streaming video. Stated otherwise, the advertisers will know, or be able to determine, how many unique IP addresses receive the advertisement. In some embodiments, the social networking site prices the advertisement at the time of broadcast based on the number of people that view the advertisement. Further still, given that many of the users logged on and receiving the streaming winner selection program will be at least registered users of the social networking site, if not paying subscribers, the advertisers may have explicit demographic information on the current viewers with pricing for the advertisements based on how much of the receiving audience fits the advertiser's desired demographic.

As an illustrative example, consider a contest whereby contestants enter pre-recorded video of themselves (and possibly others) performing a talent, such as singing within a particular genre (e.g., country music, jazz, pop). The users then tell their family, friends and/or fans about the personalized web-page, and encourage them to view the entry, vote and/or rank the entry. From the entries having the most hits, the highest number of votes, the highest average ranking, and the like, the social networking site selects a plurality of top picks, and sends a live stream of video of the winner selection program where the social networking site participants, and possibly others, view and vote on their selection for the winners. There could be a winner selection program for each genre, thereby providing a better focused set of viewers and thus more tightly defined demographic at whom advertisers may focus advertisements.

Push Advertising

In some situations, web-based companies prefer that potential customers visit the company web-page as the means of acquainting the public with the goods and services provided. However, attempts in the related-art to direct the public to particular web-pages are based on the user having at least some initial interest in the goods and/or services of provider. For example, clicking or selecting a banner advertisement takes one to the full web-page (click-through advertising), but the user needs to be intrigued enough by the banner advertisement to click on the link to initiate directing the browser to the advertiser's page. Likewise, unsolicited electronic mail may provide a short description with links to a provider's web-page. Many times, however, a consumer is completely unaware of the products and services a company may provide, and thus a banner advertisement is wholly insufficient to overcome the initial lack of interest and/or inherent prejudice against such advertising.

In order to address these concerns, and in accordance with at least some embodiments, consumers are enticed to seek particular web-pages through a combination of brain-teaser or puzzle clues and entry into giveaway contests. In particular, at any point in the online experience (examples are discussed in later sections), the consumer is given the opportunity to enter a giveaway contest (e.g., giveaway of a computer, a big screen television or cruise). While entry into the contest may be free, the consumer first finds a particular web-page where entry may be made. In some embodiments, the user may be simply directed to the particular web-page, but in other embodiments the consumer is given clues in the form of clue words to the location of the web-page and finds the entry interface based on the clue words.

The clues may take many forms. In some embodiments, the clues may be words or synonyms of words given to the consumer directly. In other embodiments, finding the clues may involve solving an initial puzzle (e.g., a word scramble, a simple cipher, a cross word puzzle where one fills in particular rows or columns, with the clue or clues forming in columns or rows respectively). Regardless of the form in which the consumer discovers the clue words, the clue words are used to search the Internet for the advertiser's web-page having the entry interface. Thus, the consumer may attempt to use the clue words, or variations of the clue words, directly as “http://” addresses. Alternatively, the consumer may invoke a search engine (e.g., Google, Ask.com) using the clue word(s), and then visit each web-page suggested by the search engine until the website hosting the entry interface is found. Thus, the consumer is pushed to the advertiser's web-page.

Regardless of the mechanism by which the consumer finds the web-page having the entry interface, the consumer enters the giveaway contest, and may also be required to answer select questions. Answering the questions as part of entering the giveaway contest may serve two functions. First, the questions provide a mechanism to gather data, possibly data of interest to the advertiser hosting the entry interface. Second, answering questions holds the user at the web-page, hopefully long enough that some portion of the web-page draws the user's attention and thus provides further opportunity for making sales of goods and/or services. In some embodiments the cost to advertisers for utilizing the push advertising will be based on the number of consumers who enter the contest by way of the entry interface.

Live Stream of Video

In the various embodiments discussed to this point with respect to the networking aspect of the social networking site, individual users or members communicate via one-on-one communication (e.g., person-to-person chat session) or in small groups (e.g., voIP where a relatively small number of people may communicate verbally). However, in accordance with alternative embodiments, substantially any member of the social networking site has the ability to broadcast a live stream of video through the social networking site. The topics of the live stream of videoing sessions could span any topic, within the limits of good taste and decorum. For example, the members may stream video of themselves or others performing comedy routines, performing a periodic (e.g., daily, weekly) special topic show (e.g., fishing, proselytizing), or performing an Internet-based morning talk show, just to name a few.

Other members of the social networking site may selectively receive any of the live streams of video, in addition to interacting with other members of the social networking site through any communication mechanism supported by the social networking site (e.g., receiving the live stream of video while performing text-based chat with the another member or the member streaming the live stream of video, or receiving the live stream of video while having voIP-based conversations with the other members or the member broadcasting the live stream of video).

An Internet-based social networking site that enables members to broadcast live streams of video may be an attractive feature that enables the provider of the social networking site the ability to charge at least an initial fee to become a member, if not a periodic fee, for continued use of the social networking site. Moreover, members that do not seek to broadcast live streams of video may also be motivated to subscribe with fee to the social networking site to enable their receipt of the live streams of video. However, in other embodiments, no fee to become a member and broadcast a live stream of video is charged, as the social networking site may make revenue based on advertisements. Stated otherwise, in some embodiments the user is not required to log-in or enter into a subscription in order to be eligible to broadcast and/or receive live streams of video.

In some embodiments, the social network site may generate revenue based on advertisements associated with the live streams of video. The association of the advertisements and the video may take many forms. In some embodiments, the social networking site may place banner advertisements in space abutting or surrounding the portion of the screen where the video is shown. In yet still other embodiments, the association of the advertisement with the live stream of video may be that the live portion of the live stream of video is temporarily interrupted, and the social networking site broadcasts the advertisement as video during the interrupted broadcast of the member.

When associating advertisements with the live stream of video, the social networking site can bill advertisers based on how many users receive the live stream of video. Stated otherwise, the social networking site will know, or be able to determine, how many unique IP addresses receive live stream of video and thus the advertisement. In some embodiments, the social networking site prices the advertisement at the time of broadcast based on the number of people that receive the advertisement. Further still, given that many of the users logged on and/or receiving the live stream of video will be at least registered users of the social networking site, if not paying subscribers, the advertisers may obtain explicit demographic information on the current viewers with pricing for the advertisements based on how much of the receiving audience fits the advertiser's desired demographic.

Putting it all Together

The various embodiments discussed to this point have been presented as standalone embodiments, and indeed may operate standalone. However, in alternative embodiments the various aspects may be integrated into a package whereby, from an advertising benefit standpoint, the integrated package may be greater than the sum of the parts.

In a first aspect of the integrated system, the user interface aspects of the enhanced social networking site integrate with social networking contests section. In particular, the user interface simplifies the process of placing contest entries, such as video clips, on the user's web-page. Moreover, the user interface is the tool, in some embodiments, whereby the user elects to enter the contest and may further define the categories to which the entry applies. For example, a user with a video clip of the user singing may be entered into the contest by way of the user interface, and the user may further limit the entry through the user interface to a particular genre of music. As yet another example, a user with a home video clip of a funny moment may use the user interface to place the video clip on the user's personalized web-page, and also may enter the video clip in the contest, with the entry limited to a particular category of funny home video (e.g., knocked down, hit in the crotch, funny wedding snafu).

Moreover, as the user views his/her own personalized web-page, and/or others view the user's personalized web-page, they may be presented with option of participating in the push advertising. In particular, the user or the user's guest may be given the opportunity to solve the initial puzzle, and then attempt to find the giveaway contest entry interface. Thus, user and/or guest viewing web-pages and casting votes during the initial culling of contest entries become the basis for participation in the push advertising for the giveaway contest.

Further still, the social networking site may provide a real-time chat feature where a user logs on and chats with other users. The social networking site thus has record of which users are actively on the Internet, and may use the real-time chat windows as a mechanism to push users to particular advertiser web-pages using the giveaway contest. For example, at particular times of the day when activity on an advertiser's servers is well below capacity, the advertiser may contract with the social networking site to invite all its users currently logged on the system (e.g., through banner advertisements bordering the user's web-pages or through direct contact through real-time chat windows) to go to the advertiser's page and enter the giveaway contest through the entry interface. In these situations, while it may be possible to invite the user's to solve the puzzle and search for the web-page with the entry interface, the advertiser and/or the social network service provider may decide to directly provide the link to the page where the entry interface resides.

Further still, the giveaway contest may boost viewership of the winner selection video program by requiring that to win, each user must be logged onto and receiving the live stream of video of the winner selection program. Thus, not only will those users/consumers interested in the outcome of the skill/talent contest be viewing the winner selection program, but also those interested in winning the giveaway contest. And as discussed above, the social networking service will be aware of all or substantially all the viewers, and will know to a high degree of certainty the number of viewers and can thus present to the potential advertisers precise demographics of the viewing audience.

Finally, a social networking site with some or all the features above may also enable substantially any user of the social networking site to broadcast a live stream of video. Other users may elect to receive any of the live stream of video available at that time, and moreover may communicate with one another and/or the user providing the live stream of video using other features (e.g., chat, voIP).

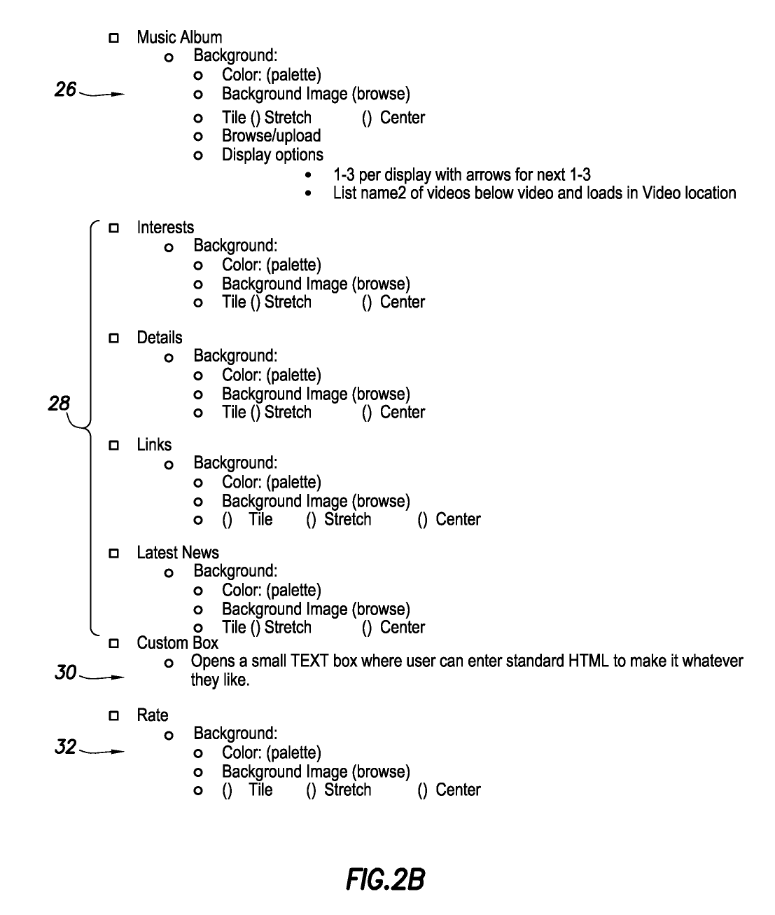

FIG. 3 illustrates a system 100 in accordance with at least some embodiments. In particular, the system 100 comprises first computer system or server 50 coupled to a plurality of users 52 by way of the Internet 54. The server 50 may be any currently available or after developed computer system which can be configured to provide at least some services associated with a social networking site (e.g., hosting chat sessions, hosting voIP sessions, hosting profile/web-pages of the users). Moreover, in alternative embodiments the services provided by the server 50 may be spread across a plurality of servers as illustrated.

Still referring to FIG. 3, the system 100 further comprises a second computer system or server 56 coupled to the plurality of users 52, and also coupled to the server 50. The server 56 is configured to accept live streams of video from any of the users 52, and to broadcast the live streams of video to any of the users 52 who elect to receive. Much like server 50, in alternative embodiments the accepting and broadcasting of video streams provided by the server 56 may be spread across multiple servers as illustrated. In some embodiments, banner advertisements may be placed video screen areas abutting the viewing screen of the live stream of video, and those banner advertisements may be provided by the server 50. In other embodiments, the server 56 may interrupt the broadcasting of the live portion of the live streams of video and play pre-recorded advertisements in the viewing screen. Further still, a user may provide an indication of the genre of the live stream of video to the server 56, which in turn may pass an indication of the genre to the server 50. In some embodiments then, the server 50 may select and provide banner advertisements and/or video advertisements during interrupted live portion of the live stream of video based on the genre of the live video.

In embodiments where the social network site makes revenue based on advertisements associated with broadcasting of live streams of video from substantially any of the plurality of users, the server 56 may be configured to determine a number of unique IP addresses receiving the live video, and such information may then be used for billing advertisers.

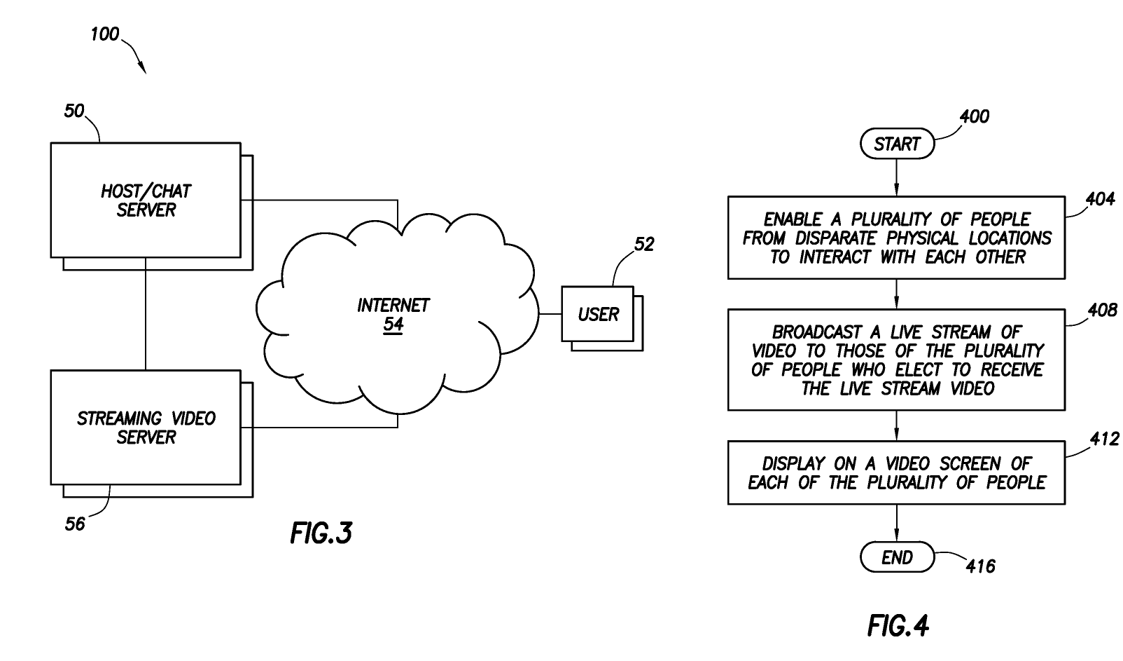

FIG. 4 illustrates a method in accordance with at least some embodiments. In particular, the method starts (block 400), and proceeds to enable a plurality of people from disparate physical locations to interact with each other (block 404). For example, the interaction may be by way of Internet-based community providing social network site functionality. A non-limited list of features the that may be provided are text-based chat between any two or more of the plurality of people, a user maintained profile for each of the plurality of people (where each user profile is available for viewing by selected others of plurality of people), a user maintained profile for each of the plurality of people (where each user profile is available to any of the selected others of plurality of people), and electronic mail messaging through the Internet-based community. Regardless of the precise nature of the interactions, the method further comprises broadcasting live streams of video to those of the plurality of people who elect to receive the live video (block 408). In accordance with at least some embodiments, the live streams of video may be provided from any of the plurality of people. Finally, the live stream of video is displayed on a video screen of each of the plurality of people (block 412) and the method ends (block 416).

From the description provided herein, those skilled in the art are readily able to combine software with appropriate general purpose or special purpose computer hardware to create a computer system and/or computer subcomponents embodying the invention, to create a computer system and/or computer subcomponents for carrying out the method of the invention, and/or to create a computer-readable media for storing a software program to implement the method aspects of the invention.

The above discussion is meant to be illustrative of the principles and various embodiments of the present invention. Numerous variations and modifications will become to those skilled in the art once the above disclosure is fully appreciated. It is intended that the following claims be interpreted to embrace all such variations and modifications.

What is claimed is:

1. A method comprising:
enabling a plurality of people from disparate physical locations to interact with each other via an Internet-based community; and
broadcasting a live stream of video through the Internet-based community to those of the plurality of people who elect to receive the live stream of video, wherein the live stream of video is provided from any of the plurality of people; and
displaying the live stream of video on a video screen of each of the plurality of people who elect to receive the live stream of video.

2. The method according to claim 1 further comprising placing a banner advertisement in an area bordering an area where the live stream of video is displayed.

3. The method according to claim 2 further comprising selecting the banner advertisement based on a genre of the live stream of video.

4. The method according to claim 2 further comprising billing an advertiser based on the number of unique IP addresses receiving the live stream of video.

5. The method according to claim 1 further comprising:
interrupting a live portion of the live stream of video; and
broadcasting advertisements during in the live stream of video the interrupting.

6. The method according to claim 5 further comprising billing an advertiser based on the number of unique IP addresses receiving the live stream of video.

7. The method according to claim 1 wherein enabling further comprises at least one selected from the group consisting of: providing text-based chat between any two or more of the plurality of people; providing a user maintained profile for each of the plurality of people, where each user profile is available for viewing by selected others of plurality of people; providing the user maintained profile for each of the plurality of people, where each user profile is available to any of the selected others of plurality of people; providing electronic messaging through the Internet-based community.

8. The method according to claim 1 wherein broadcasting further comprises broadcasting to at least some of the plurality of people without requiring a log-in process or a subscription.

9. A method of advertising comprising:
broadcasting a live stream of video over the Internet, the live stream of video associated with an advertisement for an advertiser; and
billing the advertiser based on a number of unique viewers that receive the live stream of video.

10. The method according to claim 9 wherein broadcasting further comprises broadcasting the live stream of video with a banner advertisement in space abutting a video area of a screen of a recipient.

11. The method according to claim 9 wherein broadcasting further comprises temporarily interrupting a live portion of the live stream of video, and broadcasting the advertisement as video in the live stream of video during the interrupting.

12. The method according to claim 9 wherein billing further comprises billing the advertiser based on a number of unique Internet addresses that receive the live stream of video.

13. The method according to claim 9 wherein, prior to broadcasting, selecting the advertisement based on a topic of the live stream of video.

14. The method according to claim 9 wherein broadcasting further comprises broadcasting to a plurality of people without requiring the plurality of people to pay a subscription to receive the live stream of video.

15. The method according to claim 9 wherein broadcasting further comprises broadcasting to a plurality of people without requiring the plurality of people to log in to a service.

16. A system comprising:
a first computer system coupled to the Internet, the first computer system configured to enable a plurality of people from disparate physical locations to interact with each other via a web page hosted, at least in part, on the first computer system;
a second computer system coupled to the Internet and the second computer system, the second computer system configured to accept a live stream of video from any of the plurality of people, and to broadcast the live stream of video to any other of the plurality of people, wherein the live stream of video is accessible through the web page.

17. The system according to claim 16 wherein the first computer system is further configured to place banner advertisements on the web page proximate to the live stream of video.

18. The system according to claim 16 further comprising:
wherein the second computer system is configured to accept an indication of a topic of the live stream of video; and
wherein the first computer system is configured to select an advertisement based on the topic and to place the advertisements on the web page proximate to the live stream of video.

19. The system according to claim 16 further comprising:
wherein the first computer system is further configured to place banner advertisements on the web page proximate to the live stream of video; and
wherein the system is configured to determine a number of unique Internet Protocol addresses that receive the live stream of video.

20. The system according to claim 16 further comprising wherein the second computer system is configured to interrupt a live portion of the live stream of video and broadcast an advertisement in the live stream of video during the interruption.

21. The system according to claim 20 further comprising wherein the system is configured to determine a number of unique Internet Protocol addresses that receive the live stream of video.

22. The system according to claim 16 wherein the first computer system is configured to at least one selected from the group consisting of: provide text-based chat between any two or more of the plurality of people; provide a user maintained profile for each of the plurality of people, where each user profile is available to selected others of plurality of people; provide the user maintained profile for each of the plurality of people, where each user profile is available to any of the selected others of plurality of people; provide electronic messaging through the Internet-based community.

23. The system according to claim 16 wherein the system does not require a log-in or subscription for any of the plurality of people to receive the live stream of video.
